(19) United States
(12) Patent Application Publication
(10) Pub. No.: US 2006/0175174 A1
(43) Pub. Date: Aug. 10, 2006

(54) Emergency shut-down device for power tool

(76) Inventor: Hsin-Chih Chung Lee, Chungli City (TW)

Correspondence Address: RABIN & Berdo, PC, 1101 14TH STREET, NW, SUITE 500, WASHINGTON, DC, 20005, US

(21) Appl. No.: 11/049,655

(22) Filed: Feb. 4, 2005

(51) Int. Cl. F16P 3/00

(52) U.S. Cl. 192/129 R; 192/144

(57) ABSTRACT

Disclosed is an emergency shut-down device for a power tool. The shut-down device includes a push plate rotatably mounted to the power tool, a brake assembly for selectively stopping the operation of the power tool and coupled to the push plate so that rotation of the push plate in opposite directions causes actuation and de-actuation of the push plate, and a resistance generation device arranged between the push plate and the power tool. The resistance generation device is operatively coupled to the push plate to induce a predetermined resistance against the rotation of the push plate.

### BACKGROUND OF THE INVENTION

1. Field of the Invention

The present invention relates generally to an emergency shut-down device for power tools, especially power tools for gardening purposes, and in particular to a shut-down device that incorporates a mechanism to eliminate undesired shut-down operation by properly increasing mechanical resistance against manual operation of the shut-down device so as to ensure proper actuation of the shut-down device in emergency cases while eliminating inadvertent actuation/de-actuation of the shut-down device.

2. The Prior Arts

Gardening tools are usually powered by electrical motors for driving cutters to trim plants and mow lawns. To protect an operator of the power gardening tools, some power gardening tools are provided with emergency shut-down devices, which cut off power supply of the power tool and brake the rotating or moving cutter of the power tool.

A conventional shut-down device for the power gardening tools comprises a push plate arranged at a position close to the hands of the tool operator. This allows the operator to immediately trigger the push plate for shutting down the power tool when an emergency happens. However, since the push plate is close to the operator's hand, it often happens that the push plate is inadvertently triggered by the operator's hand, who is not intending to stop the operation of the power tool. Although timely shutting down the power tool in an emergency is desired for protection of the operator or other persons from injury, undesired and inadvertent triggering the push plate may sometime cause accidents also.

It is thus desired to provide an emergency shut-down device that can timely operate for safety protection, while eliminating inadvertent actuation/de-actuation of the shut-down device for further safety protection.

### SUMMARY OF THE INVENTION

An objective of the present invention is to provide an emergency shut-down device that allows for timely actuation to shut down a power tool while effectively preventing undesired and inadvertent actuation/de-actuation of the shut-down device.

Another objective of the present invention is to provide an emergency shut-down device comprising a mechanism to induce a resistance against actuation/de-actuation of the shut-down device for eliminating inadvertent actuation/de-actuation, while allowing for timely actuation in emergency.

In an aspect of the present invention, an emergency shut-down device for a power tool is provided, comprising a push plate rotatably mounted to the power tool, a brake assembly for selectively stopping the operation of the power tool and coupled to the push plate so that rotation of the push plate in opposite directions causes actuation and de-actuation of the push plate, and a resistance generation device arranged between the push plate and the power tool, wherein the resistance generation device is operatively coupled to the push plate to induce a predetermined resistance against the rotation of the push plate.

In accordance with the present invention, the resistance generation device comprises first and second members physically engaging each other and movable with respect to each other. The second member is operatively coupled to the push plate by a link so that when the push plate is rotated, the second member is caused to move with respect to the first member. A biasing element applies a force to bias the first member against the second member for resisting the relative movement between the first and second members so as to induce the predetermined resistance against the rotation of the push plate.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is an exploded view of a power tool in which an emergency shut-down device constructed in accordance with the present invention is incorporated;

FIG. 2 is a plan view, partially in section, of the power tool of FIG. 1 in an assembled condition; and

FIG. 3 is a plan view illustrating the condition where a resistance generation device of the emergency shut-down device of the present invention is actuated.

### DETAILED DESCRIPTION OF THE PREFERRED EMBODIMENTS

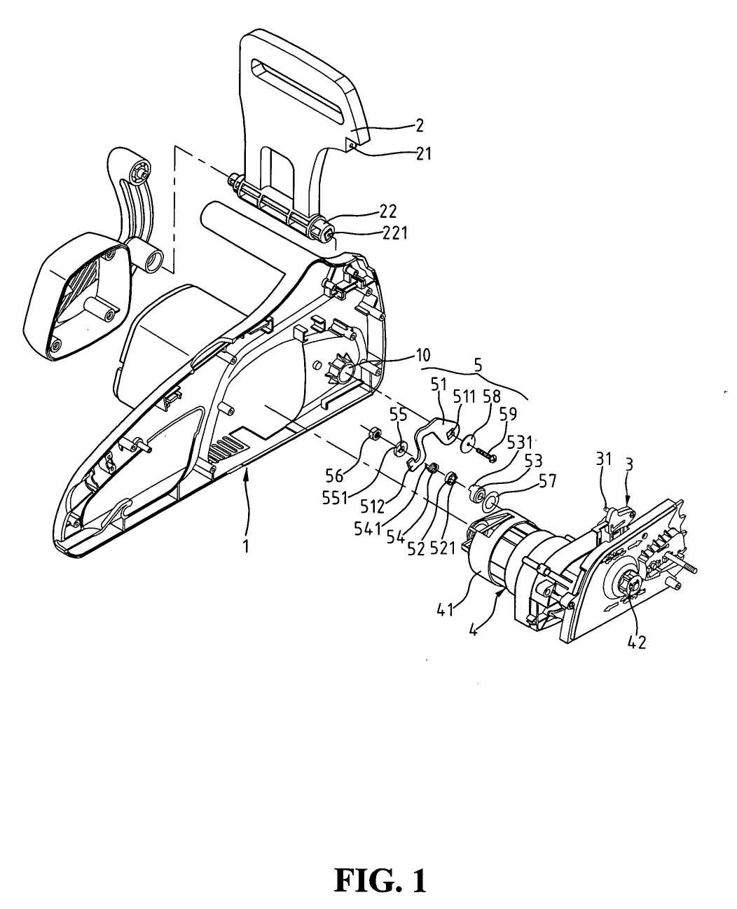

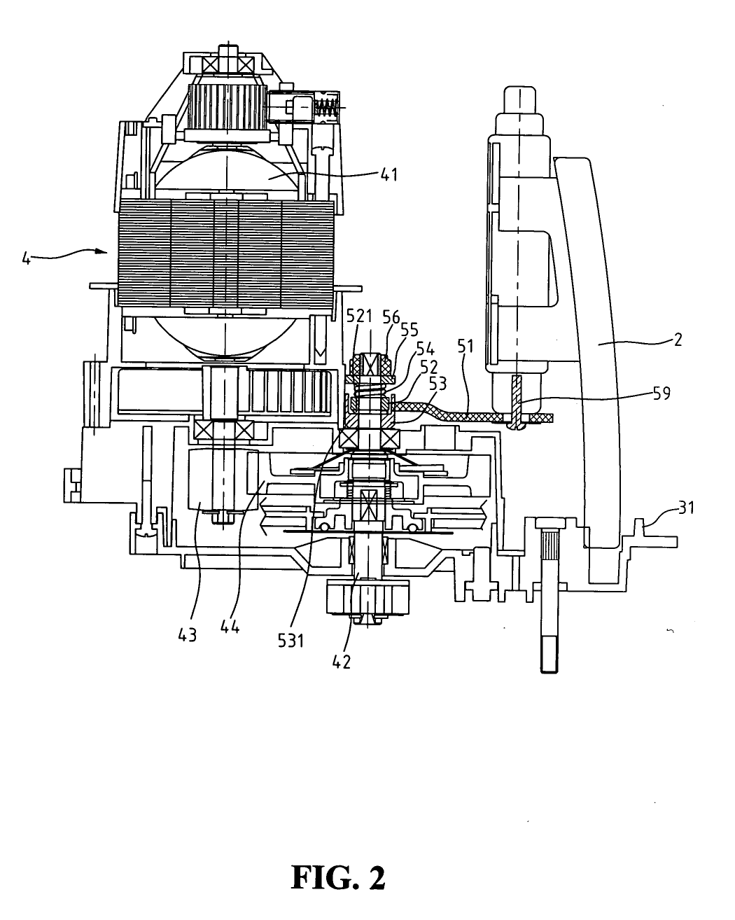

With reference to the drawings, and in particular to FIGS. 1 and 2, a portion of a power tool, generally designated with reference numeral 1, is shown. The other portion of the power tool is generally not involved in the present invention and is thus omitted in the drawings and will not be described herein. The power tool 1 comprises a power device 4 and a brake assembly 3 arranged inside a case (not labeled) and operatively coupled together. The brake assembly 3 constitutes an emergency shut-down device for the power tool 1. The power device 4 comprises an electrical motor 41 having a spindle (not labeled) that supports and rotates a first gear 43, which in turn drives a mated second gear 44. An output shaft 42 is coupled to and driven by the second gear 44 to transmit torque to a cutter mounted or otherwise coupled to the output shaft 42.

A push plate 2, serving as a manual trigger of the shut-down device, comprises a shaft 22 rotatably received in and supported by a bore 10 defined in the case of the power tool 1. The push plate 2 forms an aperture 21 that fits over a projection 31 formed in the brake assembly 3, which mechanically couples the brake assembly 3 to the push plate 2. When the push plate 2 is rotated, for example in a forward, first direction, the brake assembly 3 is actuated by the engagement between the aperture 21 and the projection 31 to shut-down the operation of the power device 4. When the push plate 2 is rotated in a reversed (backward), second direction, the brake assembly 3 is released, and the power tool 1 is allowed to resume operation.

Still referring to FIGS. 1 and 2, the emergency shut-down device comprises a damper or a resistance generation device 5 that is mounted to the output shaft 42 and operatively coupled to the push plate 2 whereby when the push plate 2 is driven by an operator of the power tool 1, the damper 5 induces a resistance against the manual operation of the push plate 2. Thus, the operator must apply a great effort to operate the push plate 2 before he can actuate/de-actuate the brake assembly 3. Thus, inadvertent actuation/de-actuation of the brake assembly 3 may be eliminated by the operator not applying the large effort to the push plate 2.

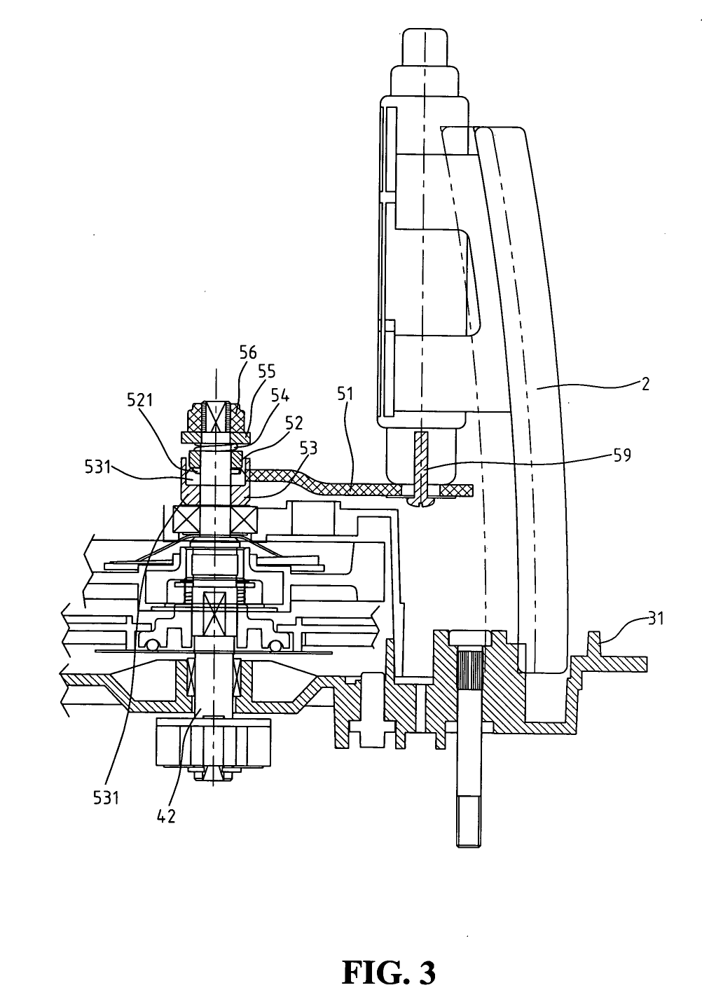

Also referring to FIG. 3, the damper 5 comprises first and second rings 52, 53 fit over the output shaft 42 and engaging each other in a relatively movable manner and a resilient element or biasing element 54 acting upon the first ring 52 to induce a resistance against the relative movement between the first and second rings 52, 53. In the embodiment illustrated, the resilient element 54 comprises a helical spring fit over the output shaft 42. A fastener 56, such as a nut, fixes the first and second rings 52, 53 and the resilient element 54 on the output shaft 42 and also retains the helical spring 54 in position.

The first ring 52 forms first teeth 521 and the second ring 53 forms second teeth 531. The first and second teeth 521, 531 physically engage each other and form camming engagement therebetween. The helical spring 54 provides a biasing force acting upon the first ring 52, which causes tight engagement between the teeth 521, 531. The engagement between the teeth 521, 531 can be broken by applying a sufficient torque to the second ring 53 to such an extent causing the teeth 531 to slide over the teeth 521 with the aid of the camming engagement therebetween.

A link 51 that is operatively coupled to the push plate 2 at a first end thereof has an opposite second end operatively coupled to the second ring 53. When an external force is applied to the push plate 2, the force is transmitted through the link 51 to the second ring 53. Thus, the external force mush be large enough to overcome the resistance between the first and second rings 52, 53 induced by the biasing force of the resilient element 54 in order to break the engagement between the teeth 521, 531 of the rings 52, 53 before the push plate 2 can be further moved for actuation/de-actuation of the brake assembly 3. This is applicable in both actuation and de-actuation of the brake assembly 3.

It is apparent to those having ordinary skills to replace the resilient element 54 with other resilient elements having different spring constants for different types of power tool.

In accordance with an embodiment of the present invention, a washer 57 is fit over the output shaft 42 to support the rotation of the second ring 53 on the output shaft 42.

In accordance with a preferred embodiment of the present invention, a spring retainer 55 is provided between the fastener 56 and the resilient element 54. The retainer 55 forms a cutoff 551 that receives and fixes an end of the helical spring 54. An opposite end of the helical spring 54 is received and fixed in a hole (not shown) defined in the first ring 52 to retain the spring 54 between the retainer 55 (and thus the fastener 56) and the first ring 52.

An example of the retainer 55 is a washer-like member that fits over the output shaft 42 and defines the cutoff 551. The fastener 56, which is preferably a nut engaging a threaded section of the output shaft 42, abuts against the washer 55 to fix the resilient element 54 and the rings 52, 53 in position.

In another embodiment of the present invention, the link 51 forms a polygonal hole 511, such as square hole, in the first end thereof. The shaft 22 of the push plate 2 forms, at an end thereof, a polygonal section 221 complementary in shape to and fit into the polygonal hole 511 of the link 51 to form operative coupling therebetween. The end of the shaft 22 defines an inner-threaded hole (not labeled) engaging with a bolt 59 that fixes the first end of the link 51 to the shaft 22 of the push plate 2. Preferably, a washer 58 is arranged between the head of the bolt 59 and the link 51.

The second end of the link 51 forms a hook 521 fit into slot (not labeled) defined in the second ring 53 to form operative and driving coupling between the link 51 and the second ring 53.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An emergency shut-down device for a power tool, comprising:
push plate rotatably mounted to the power tool;
a brake assembly for selectively stopping the operation of the power tool, the brake assembly being coupled to the push plate whereby rotation of the push plate in opposite directions causes actuation and de-actuation of the push plate; and
a resistance generation device arranged between the push plate and the power tool, the resistance generation device being coupled to the push plate to induce a predetermined resistance against the rotation of the push plate.

2. The emergency shut-down device as claimed in claim 1, wherein the resistance generation device comprises first and second members physically engaging each other and movable with respect to each other, the second member being operatively coupled to the push plate so that when the push plate is rotated, the second member is caused to move with respect to the first member, a biasing element applying a force to bias the first member against the second member so as to induce the predetermined resistance.

3. The emergency shut-down device as claimed in claim 2, wherein the first and second members are ring-like members adapted to fit over an output shaft of the power tool, the second member being rotatable with respect to the first member.

4. The emergency shut-down device as claimed in claim 2 further comprising a link operatively coupling the second member to the push plate.

5. The emergency shut-down device as claimed in claim 2, wherein the first and second members form first and second teeth engaging each other in a camming manner.

6. The emergency shut-down device as claimed in claim 4, wherein the link forms a hook engaging a slot defined in the second member for driving the second member with respect to the first member.

7. The emergency shut-down device as claimed in claim 2 further comprising fastening means for holding and supporting the first and second members and a retainer for retaining the biasing element against the first member.

8. The emergency shut-down device as claimed in claim 7, wherein the biasing element comprises a spring retained between the retainer and the first member.

9. The emergency shut-down device as claimed in claim 8, wherein the first and second members are ring-like members fit over an output shaft of the power tool, the fastening means comprising a nut engaging a threaded section of the output shaft to fix the first and second members on the output shaft, the retainer comprising a washer fit over the output shaft and fixed by the nut, the biasing element comprising a helical fit over the output shaft between the retainer and the first member.
